(19) United States
(12) Patent Application Publication
(10) Pub. No.: US 2026/0260157 A1
(43) Pub. Date: Sep. 3, 2026

(54) NO-DELAY, STOCHASTIC LIMIT CYCLE OSCILLATOR RESERVOIR COMPUTER AND RELATED METHODS

(71) Applicant: North Carolina State University, Raleigh, NC (US)

(72) Inventors: Edmon Perkins, Raleigh, NC (US); Md Raf E Ul SHOUGAT, Raleigh, NC (US); XiaoFu Li, Raleigh, NC (US); Tushar MOLLIK, Raleigh, NC (US)

(21) Appl. No.: 18/993,092

(22) PCT Filed: Jul. 12, 2023
(86) PCT No.: PCT/US2023/070046

§ 371 Date: Jan. 10, 2025

Related U.S. Application Data
(60) Provisional application No. 63/388,420, filed on Jul. 12, 2022.

(51) Int. Cl. G06N 20/00

(52) U.S. Cl. CPC G06N 20/00

(57) ABSTRACT

Various examples are provided related to reservoir computing. In one example, a physical reservoir computer includes processing circuitry having an input layer; a reservoir comprising a forced limit-cycle oscillator, the reservoir implemented without delay or feedback; and a readout layer. The forced limit-cycle oscillator can include a Hopf oscillator or a Lorenz oscillator. The processing circuitry can include analog processing circuitry, optoelectronic circuitry, or other appropriate processing circuitry.

### CROSS REFERENCE TO RELATED APPLICATIONS

This application claims priority to, and the benefit of, co-pending U.S. provisional application entitled “No-Delay, Stochastic Limit Cycle Oscillator Reservoir Computer and Related Methods” having Ser. No. 63/388,420, filed Jul. 12, 2022, which is hereby incorporated by reference in its entirety.

### STATEMENT REGARDING FEDERALLY SPONSORED RESEARCH OR DEVELOPMENT

This invention was made with government support under W911NF-20-1-0336 awarded by the Army Research Laboratory-Army Research Office. The government has certain rights in the invention.

### BACKGROUND

Reservoir computing (RC) is an unconventional computation technique, which utilizes the physics of a nonlinear dynamical system for computation. The RC scheme differs from the Turing machine principle since the computation performed by RCs do not rely on static memory. The computation is obtained by mapping the transient dynamics of the nonlinear physical system to a higher dimensional space. Some of the popular applications of RC include logical operations, spoken and handwritten digit recognition, wireless communications, complex and chaotic time-series predictions, long-term chaotic time-series prediction, image recognition, and morphological computation.

### SUMMARY

Aspects of the present disclosure are related to reservoir computing. In one aspect, among others, a physical reservoir computer comprises processing circuitry comprising an input layer; a reservoir comprising a forced limit-cycle oscillator, the reservoir implemented without delay or feedback; and a readout layer. In one or more aspects, the forced limit-cycle oscillator can comprise a Hopf oscillator or a Lorenz oscillator. The forced limit-cycle oscillator can comprise a two-state forced Hopf oscillator.

In various aspects, the processing circuitry can comprise analog processing circuitry. The analog processing circuitry can comprise operational amplifiers and multipliers. The reservoir computer can utilize a non-periodic stochastic mask. The non-periodic stochastic mask can be defined by white Gaussian noise. The processing circuitry can comprise optoelectronic circuitry. A vibratory signal can be applied to the input layer. The vibratory signal can be a speech signal. In some aspects, the readout layer can be trained to map states of the forced limit-cycle oscillator to a desired output. Training of the readout layer can comprise linear regression or ridge regression. The desired output can be a logical output. The logical output can be an XOR output, a NOT output, an AND output, or an OR output. The input layer can encode an applied signal for input to the reservoir. The applied signal can be encoded as a continuous input function.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of mapping dynamics of a Hopf oscillator for a reservoir computer, in accordance with various embodiments of the present disclosure.

FIG. 2 illustrates an example of continuous prediction along with a corresponding target signal, in accordance with various embodiments of the present disclosure.

FIG. 3 illustrates an example of a relationship between pseudo-period, Tₚ, and natural frequency of an oscillator, ω₀, in accordance with various embodiments of the present disclosure.

FIG. 4 illustrates an example of a relationship between computational ability, noise amplitude, σ, and noise bias, β, in accordance with various embodiments of the present disclosure.

FIG. 5 illustrates an example of a physical reservoir computer (PRC), in accordance with various embodiments of the present disclosure.

FIG. 6 illustrates an example of an XOR task solution using the PRC of FIG. 5, in accordance with various embodiments of the present disclosure.

FIG. 7 illustrates an example of parity task solutions using the PRC of FIG. 5, in accordance with various embodiments of the present disclosure.

FIG. 8 illustrates an example of a response of the PRC of FIG. 5 acting as fundamental logic gates, in accordance with various embodiments of the present disclosure.

FIG. 9 illustrates an example of nonlinear auto-regressive moving average (NARMA) task solutions, in accordance with various embodiments of the present disclosure.

FIG. 10 illustrates an examples of normalized mean square error (NMSE) used to evaluate performance of the PRC for the NARMA tasks, in accordance with various embodiments of the present disclosure.

FIG. 11 illustrates an example of a comparison of performance of the PRC for Santa Fe prediction tasks, in accordance with various embodiments of the present disclosure.

FIG. 12 illustrates an example of a comparison of performance of the PRC for a sunspot prediction task, in accordance with various embodiments of the present disclosure.

FIG. 13 illustrates an example of parity tasks with the Lorenz reservoir computer, in accordance with various embodiments of the present disclosure.

FIG. 14 illustrates an example of parametric sweep of limit cycle radius and harmonic forcing amplitude of a Hopf reservoir computer, in accordance with various embodiments of the present disclosure.

FIG. 15 illustrates an example of a fine resolution parametric study of the Hopf reservoir computer's resonance constant and harmonic forcing frequency based on parity tasks, in accordance with various embodiments of the present disclosure.

FIG. 16 illustrates an example of a course resolution parametric study based on the parity tasks, in accordance with various embodiments of the present disclosure.

FIG. 17 illustrates an example of effects of frequency ratio and harmonic forcing amplitude on computational ability of the Hopf reservoir computer, in accordance with various embodiments of the present disclosure.

FIG. 18 illustrates an example of effect of synchronization on computational ability of the Hopf reservoir computer, in accordance with various embodiments of the present disclosure.

FIG. 19 illustrates an example of time history of an oscillator response of the Hopf reservoir computer, in accordance with various embodiments of the present disclosure.

FIG. 20 illustrates an example of memory capacity calculations of the Hopf reservoir computer, in accordance with various embodiments of the present disclosure.

FIG. 21 illustrates an example of effect of the nonlinear activation function on performance of the Hopf reservoir computer, in accordance with various embodiments of the present disclosure.

FIG. 22 illustrates an example of echo state property index calculation for chaotic laser time-series task and parity task, in accordance with various embodiments of the present disclosure.

FIGS. 23A and 23B illustrate an example of a PRC implemented with microphone technology for sound recognition tasks, in accordance with various embodiments of the present disclosure.

### DETAILED DESCRIPTION

Disclosed herein are various examples related to reservoir computing. A simplified version of time-multiplexed reservoir computers is provided by discarding the delay and feedback lines while relying upon the physics of an oscillator to create and couple the virtual nodes. A forced limit-cycle oscillator (e.g., a Hopf oscillator or Lorenz oscillator) can be used as the base nonlinear dynamical system, which can be fabricated as a circuit. To avoid piecewise and node dependent masks, a node independent, stochastic masking signal generated from the white Gaussian noise can be used. Tuning the parameters of the Hopf oscillator, the nodes can be coupled in a way so that they have rich dynamics to be used for the RC scheme. Reference will now be made in detail to the description of the embodiments as illustrated in the drawings, wherein like reference numbers indicate like parts throughout the several views.

Due to the echo state network structure, many physical systems have been used as reservoirs, which are commonly known as physical reservoir computers (PRCs). Some of the classical PRCs include an array of Duffing oscillators, a limit cycle-based Hopf oscillator, soft robotic bodies, tensegrity structures, and origami structures. Besides systems from classical physics, quantum physical systems can be used as RCs to perform tasks from both classical and quantum domains. The naturally disordered quantum dynamics of an ensemble system can be utilized to emulate nonlinear time series, including a chaotic system. A Kerr nonlinear oscillator can be used in sine wave phase estimation using its complex amplitudes as computational nodes. A nuclear-magnetic-resonance spin-ensemble system can be used for a nonlinear dynamics emulation task by implementing a spatial multiplexing approach to increase computational power. Dissipative quantum dynamics can be used to build a quantum reservoir computer for nonlinear temporal tasks. Statistical physics has played an important role in the theoretical development of neural networks, which formed a connection between information processing and physics.

Popularly, delayed dynamical systems can be used as reservoirs from a single nonlinear node. Coupled delay systems can also be used in computing by making deep neural networks and signal processors. A simpler implementation can also be achieved by excluding the delay or feedback line. Here, a reservoir computer is built by implementing a two-state Hopf oscillator. The Hopf oscillator reservoir computer was previously studied, and it was shown that it could successfully complete several benchmark tasks. The Hopf oscillator has the capability of storing and learning information due to the presence of stable limit cycles, which also makes it suitable for building adaptive oscillators. Conventionally, a binary mask is used in a time-multiplexing procedure to create virtual nodes for computation. Besides this, noise can also be used as a mask. Previously, an eigenvalue analysis was linked with the nonresonant condition to design a reservoir computer operating near the stable equilibrium. However, the focus of this disclosure is different since the Hopf reservoir is a limit cycle-based reservoir, so the analysis would not be applicable here. It is also noted that the popular notion of the “edge of chaos” is not used in this disclosure to optimize the reservoir performance. The edge of chaos is not a necessary condition to achieve good computational ability for a reservoir computer. Hence, being distant from a chaotic region and tuning a set of network parameters can also be a route to construct a reservoir computer with good performance.

Microwave-based magnetic forced synchronization was implemented in a spintronic oscillator to increase the reservoir computing performance. The spin dynamics of a magnetic tunnel junction was also used to build a reservoir system. Additionally, a nanoscale spintronic oscillator was optimized as a reservoir, based on the magnetization dynamics. These spintronic oscillators may further be optimized by utilizing the relationship between the period of input (pseudofrequency) and the forcing as described.

In one example, a driven Hopf oscillator is studied as a reservoir computer with both a masking function and the commonly used delay line excluded; the masking function and delay lines were discarded to focus on the dynamics of the oscillator on computation. Resonance phenomena, Arnold tongues, and the Farey sequence all contribute to the performance of the Hopf oscillator as a reservoir computer. Arnold tongues refer to a phase-locked or synchronized region in the parameter space, which has a strong effect on this Hopf oscillator reservoir. Parity and chaotic laser time-series benchmarks are used to perform the parametric study of this Hopf oscillator computer. This oscillator was experimentally realized as an analog electrical circuit to study the information processing capability of the reservoir. A modified version of Shannon's information rate can be used as the performance metric for the parity tasks.

In addition, a reservoir computer can be developed from a network of virtual nodes exploiting the nonlinearity of a single Lorenz system while excluding the feedback. This can lead to a simpler and cheaper way of building a virtual node-based reservoir computer. These dynamically coupled virtual nodes can be multiplexed in time using a stochastic masking procedure. Due to the presence of noise in the system, the Euler-Maruyama method can be used to simulate the system of equations for this Lorenz reservoir computer. The resulting reservoir computer was found to be successful in performing 2nd, 3rd, and 4th order parity tasks while failing for the 5th order task. As these are logical tasks, Shannon's information metric can be used to quantify the performance of the reservoir computer.

### Hopf Physical Reservoir Computer

Reservoir computing (RC) is a bio-inspired, supervised machine-learning computational framework based on artificial recurrent neural networks (RNNs), which utilizes naturally emergent dynamics of a physical resource. Conventional machine learning schemes use backpropagation through time to train an entire recurrent neural network. This method is computationally expensive, since all the weights of the network need to be updated to mimic a target function. Echo state networks and liquid state machines are two concepts that addressed this issue in the early 2000s. Reservoir computing merges these concepts. In reservoir computing, the neural network is formed from a set of coupled nonlinear nodes, where the network is divided into three parts: an input layer, the reservoir, and the readout layer. Unlike conventional RNNs, only the readout layer requires training by a simpler training algorithm, such as linear or ridge regression. Thus, the RC architecture is much faster and more stable than conventional RNN methods, which is an advantage of this information processing framework.

There are many real-world applications of reservoir computing, including bit-wise logical operations, speech recognition, handwritten digit recognition, wireless communications, complex and chaotic time series predictions, image recognition, emulation of nonlinear time series, and morphological computation. The echo state architecture of a reservoir allows the use of physical systems as reservoir computers, also known as physical reservoir computers (PRCs). Many physical systems have been shown to perform as PRCs, including an array of nonlinear mechanical oscillators, soft robotic bodies, tensegrity structures, and origami structures.

Importantly, quantum systems can be used as PRCs. The natural disordered quantum dynamics of an ensemble system was utilized to emulate nonlinear time series, including a chaotic system. A Kerr nonlinear oscillator was used in sine wave phase estimation using its complex amplitudes as computational nodes. Nuclear-magnetic-resonance spin-ensemble system was used for nonlinear dynamics emulation task by implementing spatial multiplexing approach to increase computational power. Dissipative quantum dynamics was used to build a quantum reservoir computer (QRC) for nonlinear temporal tasks

Physical reservoir computers were initially constructed from only coupled, real dynamic nodes. Later, a virtual node-based reservoir computing method was proposed by implementing a time multiplexing approach in which delayed feedback was used as a single nonlinear dynamic node to perform computation. This method simplifies the complexity of a reservoir built from an array of physical nonlinear nodes. This approach can be used to construct physical reservoir computers for different tasks, such as an optoelectronic oscillator for optical information processing, a photonics-based passive linear fiber reservoir for signal processing, an FPGA implementation using a single autonomous Boolean logic element for pattern recognition, time-delay reservoirs for forecasting of stochastic nonlinear time series, a delayed Duffing silicon beam for parity tasks, and/or a semiconductor laser with delayed optical feedback for nonlinear time series prediction. These reservoirs can use a delay line to create the necessary nodes for computation. A simpler approach can be taken by creating the nodes without the presence of any delay or feedback line.

Here, a Hopf oscillator is used as a physical reservoir. The Hopf oscillator can also be used as the building block for adaptive oscillators, which can natively learn information without any training. The Hopf oscillator can exhibit limit cycle motion, which provides a source of memory by storing information in its dynamic states. Although a binary periodic masking function can be used for time-multiplexed reservoir, noise can also be used as the periodic mask. Here, a Hopf oscillator PRC is constructed that uses a non-periodic stochastic mask. A Hopf oscillator physical reservoir computer is fabricated as an analog circuit, which is compared with Euler-Maruyama simulations. This Hopf PRC can successfully complete benchmark machine learning tasks, including parity tasks, fundamental logic gate tasks, nonlinear dynamic emulation tasks, and various time series prediction tasks. The information rate can be used as the performance metric for logical tasks, and the normalized mean square error (NMSE) can be used for the emulation and time series tasks.

Next, the equations of motion for the stochastic Hopf oscillator PRC are presented, followed by the methodology of mapping the oscillator's dynamics to an information processing scheme is discussed for an example task by using the Euler-Maruyama simulation. The effects of the pseudo-period and the noise on computational ability are discussed and an analog circuit experiment is described. Different benchmark tasks are performed with the numerical and experimental Hopf PRC, which includes logic tasks, emulation tasks of time series, and prediction tasks. A list of parameters, states and functions used in the following discussion is provided below.

| Description | Nomenclature | Description | Nomenclature |
|---|---|---|---|
| First state | x | Second state | y |
| Input | u | Mask | m |
| Resonance constant | ω₀ | Amplitude of sinusoidal forcing | A |
| Frequency of sinusoidal forcing | Ω | Phase of sinusoidal forcing | φ |
| Parameter affecting limit cycle radius | μ | Noise amplitude | α |
| White Gaussian noise | \dot{W} | Noise bias | β |
| Re-scaled x state | X | Identity matrix | I |
| Nodal state matrix | L | Target vector | M |
| Information rate | R | Pseudo-period | Tₚ |
| Output of PRC | o | Number of nodes | N |

System equations for Hopf physical reservoir computer. The equations of motion for the Hopf oscillator are:

$$\dot{x} = ( μ - ( {x}^{2} + {y}^{2} ) ) x - {ω}_{0} y + A sin ( Ω t + ϕ ) \qquad ( 1 )$$

$$\dot{y} = ( μ - ( {x}^{2} + {y}^{2} ) ) y + {ω}_{0} x .$$

For this Hopf oscillator, x and y are the first and second states, respectively, and the sinusoidal forcing is given by A sin (Ωt+φ). A list of the parameters is given in the table above. The information is first encoded as an input, u(t), which will depend on the benchmark task being performed. The mask can be defined by white Gaussian noise as:

$$m ( t ) = σ \dot{W} + β . \qquad ( 2 )$$

Here, σ is the noise amplitude, \dot{W} is white Gaussian noise, and B is a positive bias. It should be noted that \dot{W} does not exist, but its differential form, dW, does.

To send information to the PRC to be processed, an external forcing function that contains the information signal, u(t), and the stochastic mask, m(t), can be constructed as:

$$f ( t ) = 1 + u ( t ) m ( t ) . \qquad ( 3 )$$

This external forcing function is injected into both the amplitude of the sinusoidal forcing, A, and the parameter affecting the limit cycle radius, u. Including this force, the equations for the Hopf PRC are written as:

$$\dot{x} = ( μ f ( t ) - ( {x}^{2} + {y}^{2} ) ) x - {ω}_{0} y + Af ( t ) sin ( Ω t + ϕ ) \qquad ( 4 )$$

$$\dot{y} = ( μ f ( t ) - ( {x}^{2} + {y}^{2} ) ) y - {ω}_{0} x .$$

Mapping methodology. To use the dynamics of the Hopf oscillator as a physical reservoir computer, the dynamics need to be mapped. To describe this mapping, an exclusive OR (XOR) logical task is used as an example. The Hopf PRC can be simulated using an Euler-Maruyama scheme, since the mask is stochastic. Shannon's information metric can be used to quantify the performance of the reservoir when performing logical tasks, such as the XOR operation.

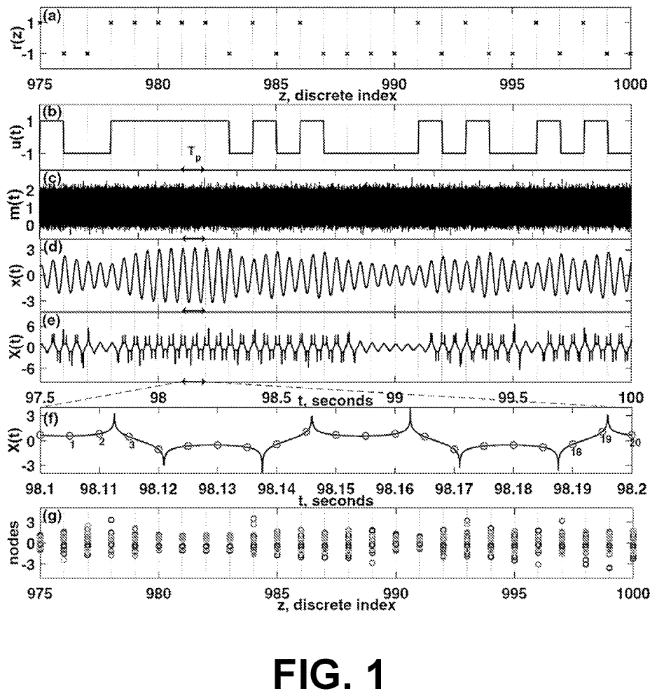

For this task, the binary “false” and “true” values are encoded as discrete negative ones and positive ones, respectively, in a discrete signal, r(z). r(z) is defined such that z∈Z⁺ and r(z)∈{−1,+1}, which is depicted in FIG. 1. Plot (a) of FIG. 1 illustrates the discrete random binary signal, r(z), and plot (b) of FIG. 1 illustrates the continuous input signal, u(t). Plot (c) of FIG. 1 illustrates an example of a stochastic masking function, m(t), plot (d) shows the time history of x(t), and plot (e) shows the rescaled time history, X(t). Plot (f) of FIG. 1 illustrates an example of 20 equidistant nodes for a single pseudo-period, Tₚ, are denoted with circles. Plot (g) of FIG. 1 shows an example of collected nodal states from the nodes for machine learning input data set, with different colors denoting different nodes. For the simulation depicted here, the parameters were set such that: μ=5, A=0.5, Ω=40π rad/s, ω₀=40π rad/s, Tₚ=0.1 second, N=20 nodes, φ=π/3 rad, σ=100, and β=1.0.

To input this into a continuous dynamical system, these values are first mapped to a continuous input function, u(t), as follows:

$$u ( t ) = r ( z ) for ( n - 1 ) {T}_{p} \leq t < ( n ) {T}_{p} , n ∈ {Z}^{+} . \qquad ( 5 )$$

This function is depicted in plot (b) of FIG. 1. Tₚ is a constant pseudo-period, in which u(t) does not change its value. Thus, for the XOR logical task, the input function, u(t)∈{−1,+1}, is a random square wave with a pseudo-period, Tₚ. This implies that each of the “true” (e.g., +1) or “false” (e.g., −1) values affect the system for an amount of time, Tₚ. The mask function, m(t), is depicted in plot (c) of FIG. 1.

The Hopf PRC system described in Eq. (4) can be numerically integrated using the Euler-Maruyama (EM) method, since the PRC is stochastic. For these simulations, the integration time step, dt=10⁻⁵ seconds, the total simulation time in this case was 3000Tₚ=300 seconds, and Tₚ=0.1 sec. This example simulation is illustrated in FIG. 1.

The time history of the x state obtained from the simulation is depicted in plot (d) of FIG. 1. Next, x(t) can be re-scaled by subtracting the mean, μₓ, and dividing by the standard deviation, σₓ, using Eq. (6):

$$X = Re ( {tanh}^{- 1} ( \frac{x - {μ}_{x}}{{σ}_{x}} ) ) . \qquad ( 6 )$$

In this equation, the inverse hyperbolic tangent function is used as a nonlinear activation function. Only the real part of

$${tanh}^{- 1} ( \frac{x - {μ}_{x}}{{σ}_{x}} )$$

is used for the subsequent steps. The time history of the X state is depicted in plot (e) of FIG. 1.

Next, equidistant nodes can be created by dividing each pseudo-period, Tₚ, equally into N(=20) nodes, as shown in plot (f) of FIG. 1. Over each pseudo-period, Tₚ, the N node values are referred to as the nodal state, which is depicted in plot (g) of FIG. 1.

The node matrix, S, is an N×K matrix; for this example, N=20 is the number of nodes over a pseudo-period, and K=3000 is the total number of pseudo-periods. Truncating the final 20% of this S matrix (600Tₚ), a new matrix, L (480Tₚ) is formed, which will be used in the training process. The reservoir computer can be trained using ridge regression, as in:

$$w = {{ML}^{T} ( {LL}^{T} + λ I )}^{- 1} \qquad ( 7 )$$

$$o ( k ) = {\sum }_{i = 1}^{N} {w}_{i} {X}_{i} ( k ) .$$

A target signal (the M vector) can be created from the encoded input based on a benchmark task, which in this case is an XOR task. For each pseudo-period, there will be one target value that is found by performing the XOR operation between the inputs, r(z) and r(z−1). In this way, the target vector, M, is found for the XOR task. Linear regression based training can then be applied to the nodal state matrix, L, to map it to the desired output using Eq. (7). In Eq. (7), w is the weight vector found after training, I is the identity matrix, λ=10⁻¹ is the regularization parameter used to avoid over-fitting, and o(k) is the prediction of the reservoir computer at the kth pseudo-period.

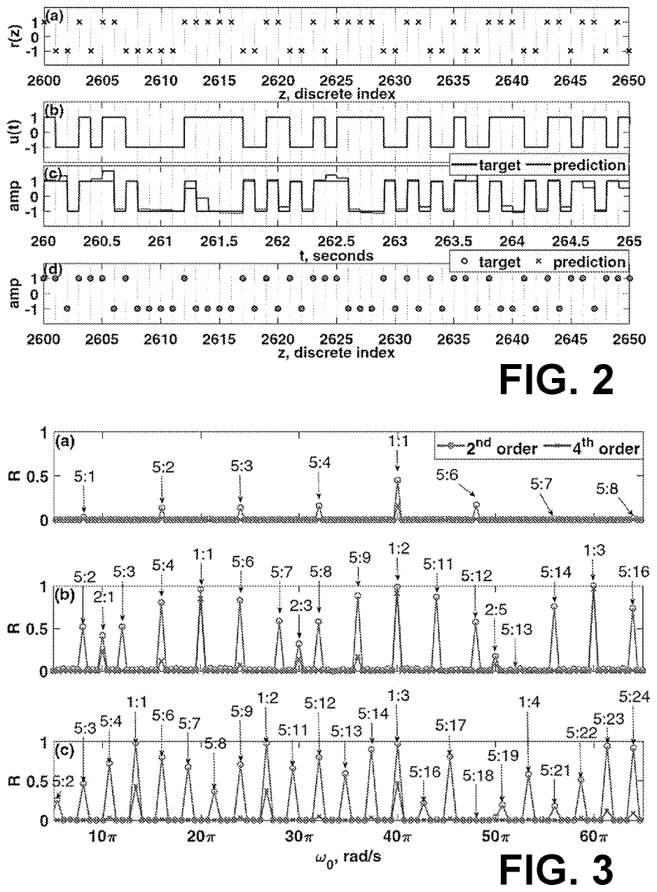

The discrete random binary input signal, r(z) and continuous input signal, u(t) are shown in plots (a) and (b) of FIG. 2, respectively. For the simulation depicted here, the parameters were set such that: μ=5, A=0.5, Ω=40π rad/s, ω₀=40π rad/s, Tₚ=0.1 s, N=20 nodes, φ=⅓ rad, σ=100, and β=1.0. Plot (c) of FIG. 2 shows this continuous prediction along with the corresponding target signal. In the final step, the prediction is binarized since XOR is a binary task, which is depicted as a discretized target and prediction in plot (d) of FIG. 2. It should be noted that a nonlinear dynamic emulation task would not require this final step of discretization.

For a logical task, the efficacy of the reservoir computer is quantified using Shannon's information rate. The information rate, R, can be defined as follows:

$$R = H ( x ) - {H}_{y} ( x ) . \qquad ( 8 )$$

Here H(x) is the Shannon entropy, which denotes how much information is encoded in a signal. This can be defined as follows:

$$H ( x ) = - {\sum }_{i} {p}_{i} {log}_{2} ( {p}_{i} ) . \qquad ( 9 )$$

In this equation, pᵢ is the probability of getting a particular bit, i. H_{y}(x) is the conditional entropy, which denotes the probability of getting an incorrect bit in the target signal:

$${H}_{y} ( x ) = - {\sum }_{i , j} p ( i , j ) {log}_{2} ( {p}_{i} ( j ) ) . \qquad ( 10 )$$

### Here

$${p}_{i} ( j ) = p ( j \vert i ) = \frac{p ( i , j )}{{\sum }_{j} p ( i , j )}$$

and p(i,j) is the joint probability distribution of the two variables, i and j, each of which can take a value of “1” or “−1” for a logical task. i is a bit from the target, and j is a bit from the prediction. The information rate, R, for this case was calculated to be 0.98 based on the prediction from the validation portion (not including in the training process). Due to the nature of this binary target signal, the Shannon entropy is 1.0, which marks the maximum value of the information rate for this task. It should be noted that the lower limit of R is zero, which would be achieved if every prediction was incorrect, while the upper limit of R depends on the task. For the parity tasks considered here, the upper limit of R is equal to one.

Pseudo-period and noise. The effects of pseudo-period and noise on the computational ability of the reservoir are next explored. For this discussion, several parity tasks (defined in Eq. (12) below) are used to understand the effects of the pseudo-period and noise on the computational ability of the reservoir.

The relationship between the pseudo-period, Tₚ, and the natural frequency of the oscillator, ω₀, is explored in FIG. 3 using 2nd and 4th order parity tasks. FIG. 3 illustrates a comparison of the reservoir's computing performance, R, on the choice of the pseudo-period, Tₚ, and the natural frequency, ω₀ using 2nd and 4th order parity tasks for (a) Tₚ=0.05 sec, (b) Tₚ=0.1 sec, and (c) Tₚ=0.15 sec. Different ratios of the natural period and pseudo-period

$$( e . g . , \frac{2 π}{{ω}_{0}} : {T}_{p} )$$

were simulated, and the ratios are depicted for peaks in the information metric. ω₀=Ω=50π rad/s is the resonance case. Parameters were set such that: μ=5, A=0.5, Ω=50π rad/s, N=1000 nodes, φ=⅓ rad, σ=15, and β=1.0.

In the plots of FIG. 3, the reservoir computer's performance was measured for three different values of Tₚ while varying the natural period,

$$\frac{2 π}{{ω}_{0}} .$$

It is found that the reservoir has better performance when the pseudo-period is an integer multiple of the natural period of the oscillator. The reservoir's performance was studied using both resonance (ω₀=Ω) and non-resonance (ω₀≠Ω) conditions. It is found that both cases can result in strong or weak computational ability depending on the fractional relationship between the natural period and the pseudo-period. However, maintaining this design can still fail to make a robust reservoir computer when Tₚ is very low (e.g., Tₚ=0.05 sec). For the remainder of this discussion, combinations of Tₚ and ω₀ are chosen such that the pseudo-period was an integer multiple of the natural period of the oscillator.

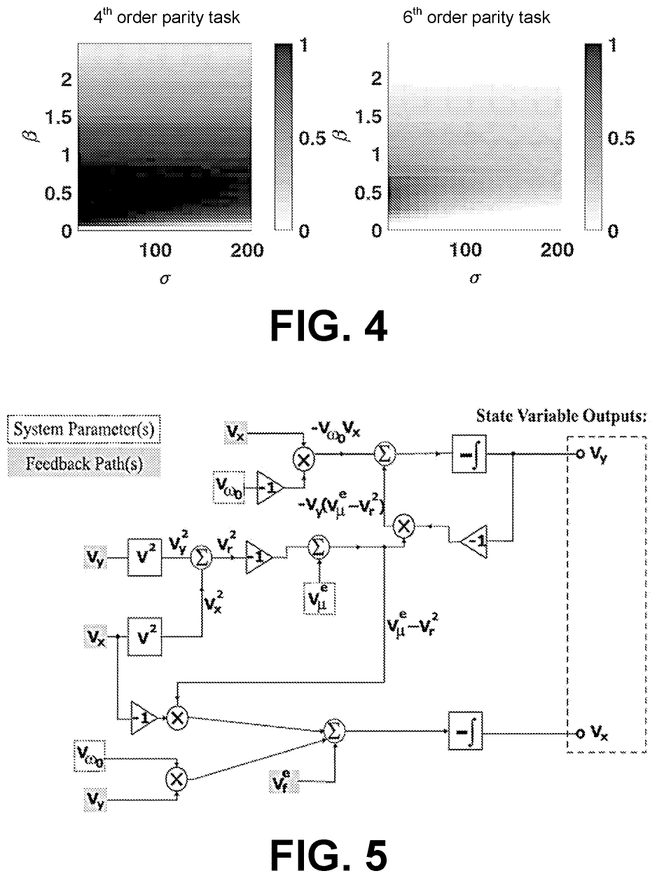

Noise is ubiquitous in physical systems. For this reason, noise was introduced into this system using a stochastic masking function. FIG. 4 shows the relationship between the computational ability, as measured with R, the noise amplitude, σ, and the noise bias, β. The simulations presented in FIG. 4 were performed for the 4th order parity task (left) and 6th order parity task (right) with the effects of σ and β shown. Parameters were set such that: μ=5, A=0.5, Ω=40π rad/s, ω₀=40π rad/s, Tₚ=0.1 sec, N=1000 nodes, and φ=⅓ rad. The reservoir was found to be robust against a certain level of noise intensity, which demonstrates its potential to be implemented under the influence of environmental noise. However, increasing noise intensity does decrease the computational ability of the reservoir. This effect may be observed for a higher order task, which requires a longer memory (e.g., the 6th order parity task of FIG. 4). When β=0, the computational ability was the lowest. Since the non-periodic noise mask with increasing noise intensity deteriorates the computational ability, it should be noted that the Hopf reservoir computer can also be built by excluding the noise mask (σ=0).

### Analog Circuit Experiment

To build a physical reservoir computer (PRC), an analog circuit implementation of Eq. (4) was designed, fabricated, and tested. The circuit's equations are given in Eq. (11):

$${\dot{V}}_{x} = - \frac{1}{{R}_{1} C} ( {V}_{μ} ( 1 + {V}_{u} {V}_{m} ) - ( {V}_{x}^{2} + {V}_{y}^{2} ) ) {V}_{x} + \frac{1}{{R}_{1} C} {V}_{{ω}_{0}} {V}_{y} - \frac{1}{{R}_{2} C} ( A ( 1 + {V}_{u} {V}_{m} ) sin ( Ω t + ϕ ) ) \qquad ( 11 )$$

$${\dot{V}}_{y} = - \frac{1}{{R}_{1} C} ( {V}_{μ} ( 1 + {V}_{u} {V}_{m} ) - ( {V}_{x}^{2} + {V}_{y}^{2} ) ) {V}_{y} - \frac{1}{{R}_{1} C} {V}_{{ω}_{0}} {V}_{x}$$

Here, Vᵤ is the input voltage, Vₘ is the stochastic masking voltage, Vᵤ is the limit cycle radius voltage, V_{ω}_{₀} is the resonance constant voltage. Vₓ and V_{y} are the states, which correspond to states x and y in Eq. (4). The circuit implementation used TL082 operational amplifiers and AD633 multipliers in standard integrator network configurations. The error tolerance was 1% for the resistors and 2% for the capacitors. The continuous input function, Vᵤ, the stochastic masking function, Vₘ, and the sinusoidal forcing, sin(Ωₜ+φ), were created in MATLAB and sent to the circuit via a National Instrument (NI) cDAQ-9174. This cDAQ-9174 also collected the Vₓ and V_{y} states. A sampling frequency of 10⁵ samples/s was used to collect data for all the experiments. The resistor values were chosen such that R₁=10 kΩ and R₂=100 kΩ, and the capacitor values were chosen such that C=0.1 μF. FIG. 5 shows a simplified schematic for the Hopf PRC, with states V_{y} and V_{y}, and where

$${V}_{μ}^{e} = {V}_{μ} ( 1 + {V}_{u} {V}_{m} ) and {V}_{f}^{e} = A ( 1 + {V}_{u} {V}_{m} ) sin ( Ω t + ϕ ) .$$

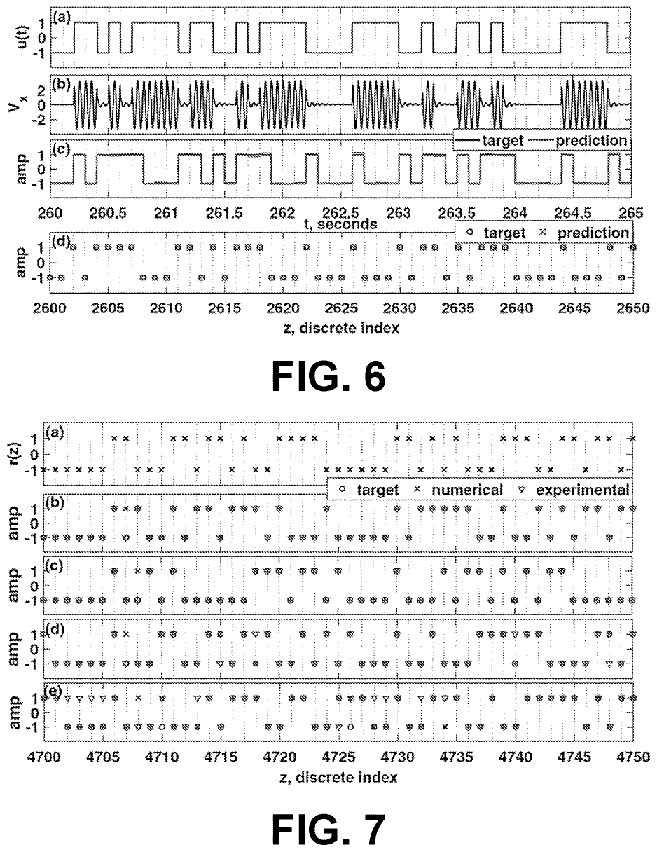

The Vₓ state can be treated in the same manner that the x state was treated in the “Mapping methodology” section. That is, the V_{y} state will be rescaled using Eq. (6), and then the rescaled state will be used to form the nodal state matrix, L. The target signal vector, M, will be created following the same process discussed in “Mapping methodology” section. Finally, Eq. (7) can be used to train the PRC to map input data to the desired output values. As an example, the analog circuit Hopf PRC was used to solve the XOR task as in the previous section, which is depicted in FIG. 6. Plot (a) of FIG. 6 shows the input voltage signal, Vᵤ, plot (b) of FIG. 6 illustrates the time history of Vₓ, plot (c) of FIG. 6 shows the XOR target signal, M, and the prediction, and plot (d) of FIG. 6 shows the discretized prediction. The calculated information metric is R=1.0. For the experimental results depicted here, the parameters were set such that: V_{μ}=5 volts, A=0.5 volt, Ω=40π rad/s, Va)=40π volts, Tₚ=0.1 sec, N=20 nodes, φ=⅓ rad, σ=10 volts, and β=1.0 volt. The information rate, R, for this case was calculated to be 1.0 based on the prediction from the validation portion (not including in the training process).

Benchmark tasks for Hopf PRC. The Hopf PRC was numerically and experimentally tested with three benchmark tasks: (1) logic tasks, (2) emulation tasks of time series, and (3) prediction tasks. Logic tasks include the fundamental logic gate tasks and parity tasks of different orders. Emulation tasks of time series test the PRC's ability to reproduce nonlinear auto regressive moving average (NARMA) tasks of different orders. Prediction tasks include Santa Fe time series and sunspot prediction tasks.

Logic benchmark tasks. Parity tasks. The computing efficacy of the reservoir was first evaluated with parity benchmark tasks. Since it is a logical task, the input function, u(t), is generated with a random binary signal, r(z), as discussed in the “Mapping methodology” section. The nth order parity function, Pₙ, can be defined by the following equation:

$${P}_{n} ( t ) = {\prod }_{i = 0}^{n - 1} u ( t - {iT}_{p} ) . \qquad ( 12 )$$

As n increases, this task will utilize more memory and nonlinearity from the reservoir. As given in the “Mapping methodology” section, Shannon's information metric can be used to measure the performance of the PRC for logic tasks. For n=1, the first-order task does not require any memory from the input of the previous pseudo-period, so the task is linear. For n>1, the task is nonlinear, which demands that the reservoir computer must also possess memory and the nonlinear separation ability. In FIG. 7, the ability of the Hopf PRC to follow parity tasks of 2nd to 5th order, both experimentally and in simulations, is illustrated. FIG. 7 illustrates a comparison of the performance of the PRC for parity tasks. Plot (a) of FIG. 7 shows the discrete input function, r(z). Plot (b) of FIG. 7 shows the 2nd order parity task (information metric: Rₑₓₚ=1.00, Rₛᵢₘ=0.98), plot (c) of FIG. 7 shows the 3rd order parity task (information metric: Rₑₓₚ=1.00, Rₛᵢₘ=0.98), plot (d) of FIG. 7 shows 4th order parity task (information metric: Rₑₓₚ=0.68, Rₛᵢₘ=0.93), and plot (e) of FIG. 7 shows the 5th order parity task (information metric: Rₑₓₚ=0.31, Rₛᵢₘ=0.74). Parameters were set such that: V_{μ}=μ=5, A=0.5, Ω=40π rad/s, V_{ω}_{₀}=ω₀=40π rad/s, Tₚ=0.1 sec, N=1000 nodes, φ=⅓ rad, σ=15, and β=1.0, and a total time of 5000Tₚ=500 seconds (only a portion of the discrete prediction is shown). The initial 4000Tₚ=400 seconds were used for training, and the final 1000Tₚ=100 seconds were used for testing. The performance difference between the PRC experiment and the simulation may be attributed to the presence of nonlinear circuit components in the analog circuit, which are not represented in Eq. (11). For instance, Vᵤ must jump between −1 and +1, but this instantaneous change takes a finite amount of time in the circuit.

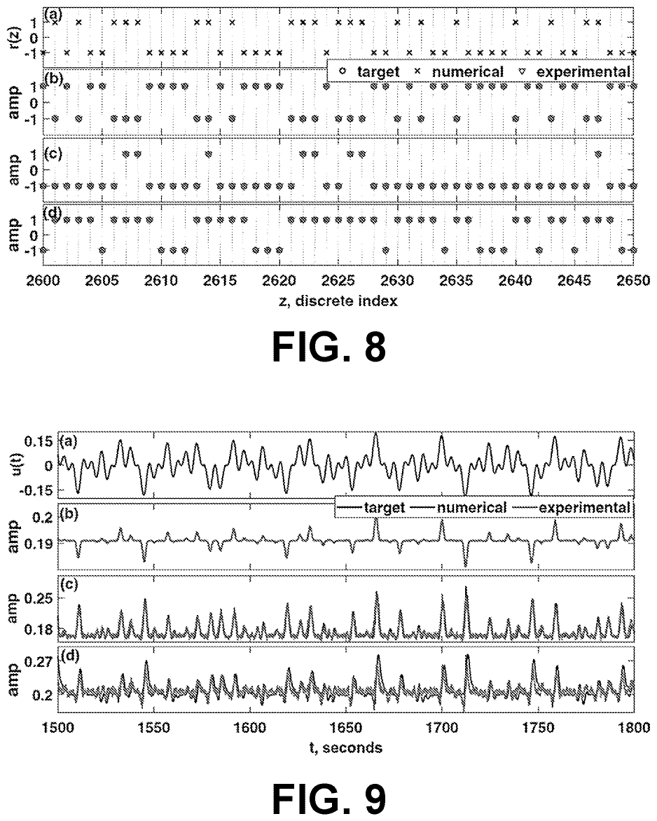

Fundamental logic gate tasks. The computing performance of the reservoir is also assessed with fundamental logic gates: NOT (¬), AND (Λ), and OR (v). The input function, u(t), can be generated with a random binary signal as discussed in “Mapping methodology” section, and the Shannon's information metric is used again to measure the performance of this PRC. FIG. 8 depicts the response of the Hopf PRC acting as fundamental logic gates, both experimentally and in simulations. FIG. 8 illustrates a comparison of the performance of the PRC for parity tasks. Plot (a) of FIG. 8 shows the input function, u(t), plot (b) shows NOT (¬) gate, plot (c) shows AND (Λ) gate, and plot (d) shows OR (v) gate. For all numerical and experimental results, the information rate was at the theoretical maximum. The Hopf PRC can act as any of the fundamental logic gates. Parameters were set such that: V_{μ}=μ=5, A=0.5, 0=40π rad/s, V_{ω}_{₀}=ω₀=40π rad/s, Tₚ=0.1 sec, N=1000 nodes, φ=n/3 rad, σ=15, and β=1.0, and a total time of 3000Tₚ=300 seconds (only a portion of the discrete prediction is shown). In all cases, the Hopf PRC achieved an information rate that was maximal.

Emulation tasks. The reservoir was also evaluated with emulation tasks. The nonlinear auto-regressive moving average (NARMA) time series can be used to test whether the reservoir possesses adequate nonlinearity and long time lags. These tasks show the multi-tasking capability of the reservoir. NARMA tasks from the 2nd to 20th orders are used to test the reservoir. A NARMA task of order n is given in Eq. (13), where the initial target values are set to 0.19:

$${M}_{2} ( j + 1 ) = 0.4 {M}_{2} ( j ) + 0.4 {M}_{2} ( j ) {M}_{2} ( j - 1 ) + 0.6 {u}^{3} ( j Δ t ) + 0.1 \qquad ( 13 )$$

$${M}_{n} ( j + 1 ) = α {M}_{n} ( j ) + ζ {M}_{n} ( j ) ( {\prod }_{i = 0}^{n - 1} {M}_{n} ( j - i ) ) + γ u ( ( j - ( n - 1 ) ) Δ t ) u ( j Δ t ) + δ .$$

$$u ( t ) = 0.2 sin ( 2 π {f}_{1} t ) sin ( 2 π {f}_{2} t ) sin ( 2 π {f}_{3} t )$$

In Eq. (13), Mₙ is the target of the system, n is the order of NARMA task,

$$( {f}_{1} , {f}_{2} , {f}_{3} ) = ( \frac{2.11}{500} , \frac{3.73}{500} , \frac{4.33}{500} ) ,$$

and (α,ζ,γ,δ)=(0.3, 0.05, 1.5, 0.1). u(t) is the continuous input that is used to force the Hopf PRC, which is a function of three sinusoidal functions. It should be noted that this formulation of the NARMA emulation task is non-standard. The u(t) given in Eq. (13) was used for other dynamic systems in which inertia played a large role. Similarly, this non-standard NARMA task can be used here to evaluate this analog circuit reservoir. The reservoir emulates this nonlinear function, but it should be noted that the correlation present in Eq. (13) does not allow a definitive evaluation of the long-term memory characteristics of this reservoir.

In the simulations and experiments, Δt=0.1 sec, and the sampling rate was 10⁵ samples/second. FIG. 9 shows several NARMA tasks. Instead of the information rate, the normalized mean square error (NMSE) is used to evaluate the performance of the reservoir computer for the NARMA tasks:

$$NMSE = \frac{{\sum }_{j = {j}_{0}}^{{j}_{f}} {( {M}_{n} ( j + 1 ) - {o}_{n} ( j + 1 ) )}^{2}}{{\sum }_{j = {j}_{0}}^{{j}_{f}} {M}_{n}^{2} ( j + 1 )} . \qquad ( 14 )$$

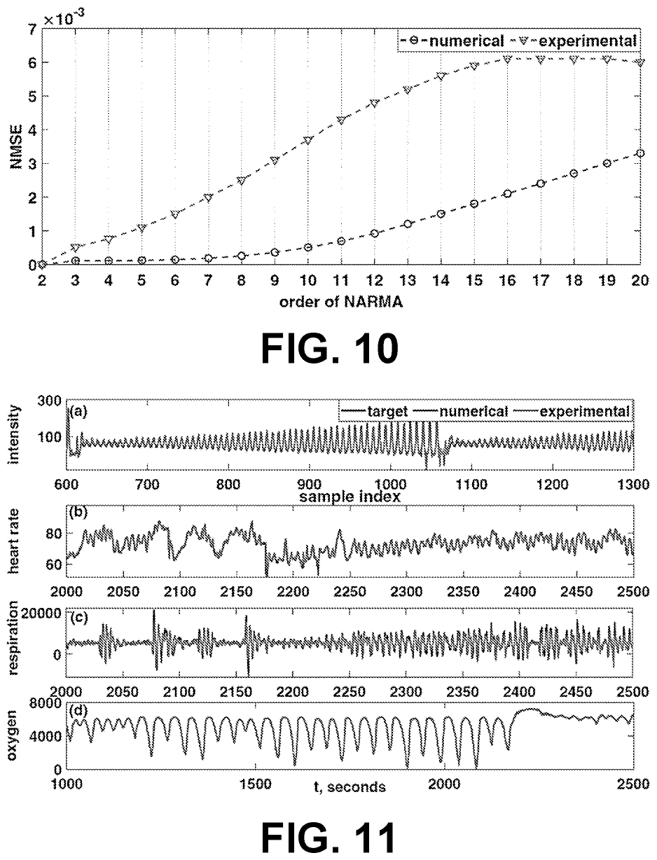

The final 20% of the target signal (16,000-20,000 pseudo-periods) was used for the validation. Mₙ is the target, and on is the prediction from the reservoir computer. In Eq. (14), j₀ is the starting time step, and j_{f} is the ending time step from the test section. FIG. 9 illustrates a comparison of the performance of the PRC for NARMA tasks. Plot (a) of FIG. 9 shows input function, u(t). Plot (b) of FIG. 9 shows the 2nd order NARMA task (performance metric: NMSEₑₓₚ=2.8181×10⁻⁶, NMSEₛᵢₘ=7.8199×10⁻⁷), plot (c) of FIG. 9 shows the 10th order NARMA task (NMSEₑₓₚ=0.0037, NMSEₛᵢₘ=5.0362×10⁻⁴), and plot (d) shows the 20th order NARMA task (NMSEₑₓₚ=0.0060, NMSEₛᵢₘ=0.0033). Only a portion of the result is shown in each plot. Parameters were set such that: V_{μ}=μ=5, A=0.5, 0=40π rad/s, V_{ω}_{₀}=ω₀=40π rad/s, Tₚ=0.1 sec, N=1000 nodes, β=π/3 rad, σ=15, and β=1.0. FIG. 10 shows a plot of the NMSE of the 2nd to 20th order NARMA tasks for the simulation and experiment. Parameters were set such that: V_{μ}=μ=5, A=0.5, 0=40π rad/s, V_{ω}_{₀}=ω₀=40 π rad/s, Tₚ=0.1 sec, N=1000 nodes, Ω=π/3 rad, σ=15, and β=1.0. From the plots in FIGS. 9 and 10, the numerical simulations of the Hopf PRC show superior performance as compared to the experiment. However, both have an acceptable performance until the 20th order task. The PRC can perform much higher order NARMA tasks than the order of the parity tasks.

Prediction tasks. Santa Fe task. Time series forecasting is an important benchmark for a reservoir. The Santa Fe time series was first used in a time series forecasting competition as a benchmark test. The Santa Fe time series data set A is a univariate time series found from the recorded intensity of a chaotic far-infrared-laser. The target signal can be generated to predict the value at the next time step based on the values of the current and previous time steps. FIG. 11 illustrates a comparison of the performance of the PRC for Santa Fe prediction tasks, which shows the Hopf PRC's performance on this laser time series for both the experiment and the numerical simulations. NMSE is used as the performance metric. Plot (a) of FIG. 11 shows the Santa Fe chaotic time series of a laser intensity prediction task (performance metric: NMSEₑₓₚ=0.0615, NMSEₛᵢₘ=0.02), plot (b) shows the Santa Fe heart rate prediction task (NMSEₑₓₚ=6.0258×10⁻⁴, NMSEₛᵢₘ=6.5060×10⁻⁴), plot (c) shows the Santa Fe respiration force prediction task (NMSEₑₓₚ=0.1826, NMSEₛᵢₘ=0.1753), and plot (d) shows the Santa Fe blood oxygen concentration prediction task (NMSEₑₓₚ=3.3287×10⁻⁴, NMSEₛᵢₘ=1.7×10⁻⁴). Parameters were set such that: V_{μ}=μ=5 volts, A=0.5 volts, 2=40π rad/s, V_{ω}_{₀}=ω₀=40× volts, Tₚ=0.1 sec, N=1000 nodes, φ=π/3 rad, σ=15 volts, and β=1.0 volt. Only a portion of the result is shown in each figure.

Santa Fe time series data set B is a multivariate time series found from the sleep laboratory of the Beth Israel Hospital (current name: Beth Israel Deaconess Medical Center) in Boston, Massachusetts. This data set was taken from the MIT-BIH Polysomnographic Database record (slp60) and submitted to the Santa Fe Time Series Competition in 1991. The heart rate, chest volume (respiration force), and blood oxygen concentration comprise the target.

For each of these time series, the target signal was again generated to predict the next step based on the values of the current and previous time steps. In each case, the original time series was normalized to use as the input. Plots (b), (c) and (d) shows the reservoir computer's performance in predicting subsequent values of the heart rate, respiratory force, and blood oxygen concentration, respectively, through both experiments and numerical simulations. The NMSE was calculated in each case to evaluate the performance of the reservoir.

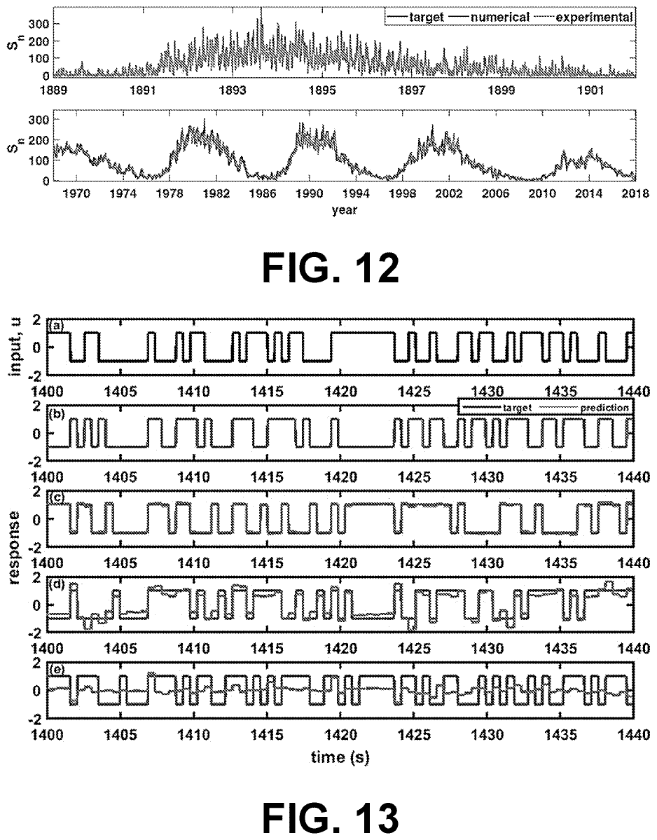

Sunspot prediction task. The prediction of the total number of sunspots (Sn) is also a one-step time series prediction task similar to the Santa Fe time series. Daily and monthly total sunspot numbers were used in one step forecasting purpose by the reservoir computer. The needed data set was taken from WDC-SILSO, Royal Observatory of Belgium, Brussels. Again, for each of the time series, the target signal was generated to predict the next value based on the value of the current and previous time steps, and the original time series is normalized to use as the input to the oscillator. FIG. 12 illustrates a comparison of the performance the sunspot prediction (Sn) task. The top plot of FIG. 12 shows the reservoir's performance in predicting the next steps of the daily total counted sunspots, and the bottom plot of FIG. 12 shows the performance in predicting monthly counted sunspots. Again, the NMSE is used to evaluate the reservoir's efficacy for this task. Daily total number of sunspot prediction task, for both the experiment and the numerical simulations, is shown in the top plot of FIG. 12 (performance metric: NMSEₑₓₚ=0.0548, NMSEₛᵢₘ=0.0534). Monthly mean total number of sunspot prediction task is shown in the bottom plot of FIG. 12 (performance metric: NMSEₑₓₚ=0.0595, NMSEₛᵢₘ=0.0455). Parameters were set such that: V_{μ}=μ=5 volts, A=0.5 volts, Ω=40π rad/s, V_{ω}_{₀}=ω₀=40π rad/s, N=1000 nodes, φ=⅓ rad, σ=15 volts, and β=1.0 volt.

Here, the Hopf oscillator was explored as a physical reservoir computer through employing a time-multiplexed, node-based architecture with a stochastic masking function. Discarding the regularly used delay lines, this Hopf PRC is a simple and cheap method for creating a physical reservoir computer. Since quantum systems are capable of limit cycle motion, this Hopf PRC formulation may be applicable for quantum PRCs. The Euler-Maruyama method was used for the numerical simulations of this Hopf PRC. An analog circuit of this Hopf PRC was developed, fabricated, and tested. The Hopf PRC was found to possess multi-tasking capability, since it was shown to perform logic operations, emulation tasks, and time series prediction tasks. Taking inspiration from adaptive oscillators, the input signal was injected into multiple locations, including the parameter that affects the limit cycle radius and the amplitude of the sinusoidal forcing. Additionally, the masking function used in this PRC is stochastic. Since this PRC architecture is tested with noise, it also suggests that this reservoir computer should be robust to environmental noises in practical implementations.

Reservoir Computing with Lorenz System

The information processing capability of the Lorenz system, which was one of the first systems shown to exhibit chaos, is explored from the perspective of reservoir computing. The Lorenz system can be used as a reservoir computer with an echo state network approach to separate superimposed chaotic signals and with a small world and scale-free network approach to reproduce long term nonlinear characteristics of a system. A coupled Lorenz oscillator can also be used as a reservoir computer for signal reconstruction by exploiting the continuous transient oscillatory dynamics. Here, the Lorenz system is implemented as a reservoir computer by coupling a number of virtual nodes via a time multiplexing approach. A Mackey-Glass oscillator was used to perform a speech recognition task, and a silicon beam has also been used as a reservoir computer by exploiting the Duffing nonlinearity to perform parity tasks.

The set of equations for the Lorenz reservoir computer used in the following discussion are given by:

$$\dot{x} = σ ( {y}_{new} - x ) \qquad ( 15 )$$

$$\dot{y} = x ( {ρ}_{new} - z ) - {y}_{new} ,$$

$$\dot{z} = {xy}_{new} - β z$$

where y_{new}=y+u(t)m(t) and ρ_{new}=ρ(1+u(t)m(t)) sin (Ωt+φ), u(t) is the input of the reservoir computer, and m(t)=a(W+b) is the masking function based on stochastic forcing, a is the noise amplitude, W is white Gaussian noise, and b is a positive constant bias. The input can be defined as u(t)−r(z) for (n−1)τ≤t<(n)τ, where r(z) is a discrete signal that takes a value of {−1,1} and n,z∈Z⁺. The performance of this reservoir computer has been evaluated by using parity tasks, where u(t)=[−1,+1] is a random square wave with a pseudo-period, τ. θ is the time difference between two consecutive nodes

$$( θ = \frac{τ}{N} ) .$$

By numerically integrating Eq. 15 with the Euler-Maruyama method, equidistant virtual nodes (N=100) are formed. Next, the following set of equations is used to train the reservoir computer:

$$w = {{ML}^{T} ( {LL}^{T} + λ I )}^{- 1} \qquad ( 16 )$$

$$o ( k ) = {\sum }_{i = 1}^{N} {w}_{i} y ( k τ - \frac{τ ( N - i )}{N} ) .$$

The reservoir computer is trained using the y-state of the 100 nodes (the L matrix) for each pseudo-period, τ. A target signal (the M vector) is made from the input's time history following a benchmark task. Linear readout training is applied to the nodal states to map it to the desired output using Eq. 16, where w is the weight vector found after training, I is the identity matrix, λ=10⁻¹ is the regularization parameter used to avoid over-fitting, and o(k) is the prediction of the reservoir computer at the kth time step.

The nth order parity function, Pₙ, is defined by

$${P}_{n} ( t ) = {\prod }_{i = 0}^{n - 1} u ( t - i τ ) .$$

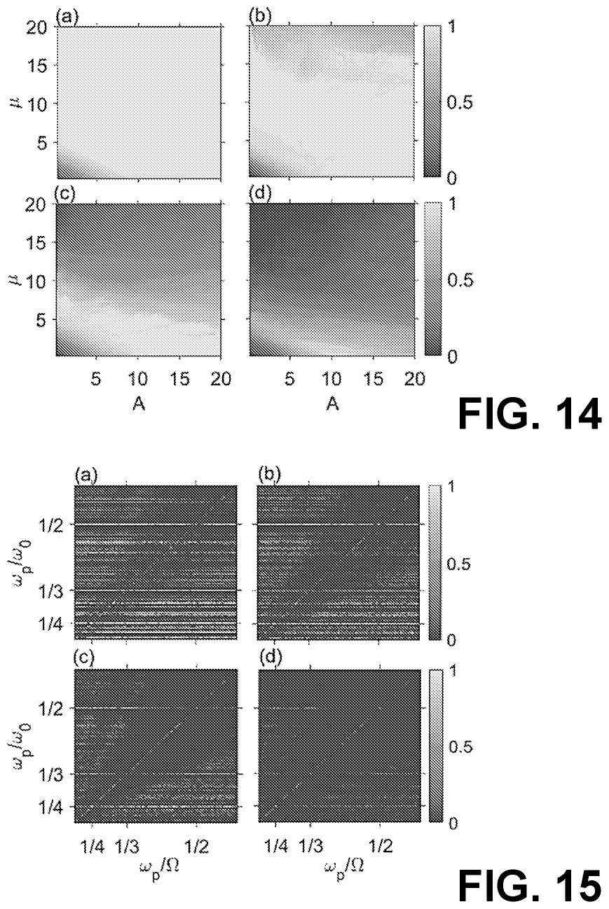

As n increases, this task utilizes more memory and nonlinearity of the reservoir computer to perform the task. Since these parity tasks are logical in nature, Shannon's information metric is used to measure the efficacy of the reservoir computer. The information metric, R, is defined as follows:

$$H ( x ) = - {\sum }_{i} {p}_{i} {log}_{2} ( {p}_{i} ) \qquad ( 17 )$$

$${H}_{y} ( x ) = - {\sum }_{i , j} p ( i , j ) {log}_{2} ( {p}_{i} ( j ) ) ,$$

$$R = H ( x ) - {H}_{y} ( x )$$

where H(x) is the Shannon entropy and H_{y}(x) is the conditional entropy. The first 80% of the time history is used for training the reservoir, and the remaining 20% is used for testing. FIG. 13 illustrates an example of parity tasks with the Lorenz reservoir computer. Simulation time was 1440 seconds, with dt=0.0001 sec, N=100, t=0.48 sec, 0=0.0048 sec, b=1.5, σ=10, β=2, σ=10, β=8/3, Ω=100π rad/s, and β=π/3 rad. Plot (a) of FIG. 13 shows input, u(t), plot (b) of FIG. 13 shows the 2nd order parity task, plot (c) of FIG. 13 shows the 3rd order parity task, plot (d) of FIG. 13 shows the 4th order parity task, plot (e) of FIG. 13 shows the 5th order parity task. FIG. 13 shows that for every time step, bit-wise prediction accuracy of the reservoir computer is 100% for 2nd, 3rd. and 4th order parity tasks, which corresponds to R=1.0. However, the 5th order parity task has an information metric near zero.

The Lorenz system is studied here to process information using the time multiplexed virtual node-based reservoir computing framework. In this work, a stochastic masking function was used. Discarding the feedback and delay, a simpler and cheaper way of developing a reservoir computer is shown.

Dynamic Effects on Reservoir Computing with a Hopf Oscillator

The nonlinear system is perturbed by an input signal, which carries the information to be processed. The input u(t) is embedded into the reservoir dynamics using the single nonlinear node as follows:

$$u ( t ) = r ( z ) for ( n - 1 \} {T}_{p} ⩽ t < ( n ) {T}_{p} , \qquad ( 18 )$$

$$f ( t ) = 1 + u ( t ) .$$

Here, r(z) is a discrete signal, which encodes logical values sequentially. This discrete signal is then mapped to a continuous function as described by Eq. (18), where n, z∈Z⁺. Since r(z) is a random sequence of logical statements, u(t) is a random square wave with a pseudo-period Tₚ and a pseudo-frequency

$${ω}_{p} = \frac{2 π}{{T}_{p}} .$$

The Hopf reservoir computer can be described by the equations of motion in Eq. (4). This system is a two-state forced Hopf oscillator, where x and y are the states, Ω is the harmonic forcing frequency, ω₀ is the resonance constant, and μ is a parameter controlling the limit cycle radius. The governing equation of the Hopf RC in Eq. (4) is numerically integrated, and the x state is then scaled by subtracting the mean and dividing by the standard deviation. Next, dividing each pseudo-period equally, N virtual nodes are collected from each pseudo-period Tₚ. The nodal states are then nonlinearly scaled using a nonlinear activation function tanh⁻¹ x. Some 80% of the scaled nodal states are used for the training process, and the remaining 20% are used for testing the RC's performance. These virtual nodes, which are extracted by down-sampling the time histories, are similar to the nodes found in a delay-based reservoir. Since there is only one real node, which is the oscillator itself, the other nodes are called virtual in keeping with the terminology of delay-based reservoirs. However, the Hopf RC studied in this paper does not include any delay lines nor masking functions (time multiplexing), which simplifies the system.

The reservoir computer is trained using ridge regression with Tikhonov regularization as shown in Eq. (7). Here, M is the target vector, which the reservoir should match, X is the scaled nodal states, L is the matrix containing the nodal states of the reservoir. λ, which is set to 10⁻¹, is the regularization parameter to avoid overfitting, I is the identity matrix, N is the number of nodes, w is the weight vector, which is found from the training procedure, and o(k) is the reservoir's prediction, where k∈Z⁺.

The δ delayed nth order parity function Pₙ is defined by the following equation:

$${P}_{n , δ} ( t ) = {{\prod }_{i = 0}}^{n - 1} u [ t - ( i + δ ) {T}_{p} ] , \qquad ( 19 )$$

where δ∈Z⁺ is the delay. For the tested parity tasks here, δ=0 is used. For n=2, Eq. (19) is the second order parity, which is the exclusive or (XOR) task v. Since this examination only deals with parity benchmarks that are logical tasks, the input u(t)={−1,+1} is chosen randomly for each pseudo-period. Hence, the final prediction of the reservoir is also binarized, making a high (+1) or low (−1) bit. Shannon's information rate can be used to evaluate the reservoir's performance. The logical bits are used to calculate the information metric R as defined in Eq. (8). Here H(x) is the Shannon entropy, which is a measure of the encoded information in a signal. This can be defined as in Eq. (9), where pᵢ is the probability of getting a particular bit, i. H_{y}(x) is the conditional entropy, which measures the probability of getting an incorrect bit in the target signal, as defined in Eq. (10).

Here

$${p}_{i} ( j ) = p ( j \vert i ) = \frac{p ( i , j )}{{\sum }_{j} p ( i , j )}$$

and p(i,j) is the joint probability distribution of the two variables, i and j, which can be valued at “1” or “−1” for a logical task. i is associated with the target signal, whereas j is the associated bit value from the prediction signal of the RC. It should be noted that the maximum value of R is 1.0 for these parity tasks. Using Eq. (4), the Hopf RC was fabricated as an analog circuit. The circuit was built using TL082 operational amplifiers and AD633 multipliers in standard integrator network configurations. National Instrument cDAQ-9174 was used as the data acquisition device.

Parametric Studies. The dynamic limits of the Hopf reservoir computer will next be explored by studying the effects of different parameters on its information processing capability. The performance is quantified using the information rate for various parameter combinations and orders of the parity tasks. The results render a deeper understanding of the interplay of the oscillator's dynamics and its computational ability as a reservoir computer. Some of these results can be used as guiding principles for tuning other virtual node-based reservoir computers.

The input signal to the Hopf RC is embedded into the oscillator through the limit cycle radius μf(t) and the harmonic forcing amplitude Af(t). Hence, tuning the parameters μ and A potentially controls the amount of information being sent into the oscillator. A parametric sweep of this two-parameter space is presented in FIG. 14, which illustrates an example of the parametric study of the Hopf RC's limit cycle radius constant μ and harmonic forcing amplitude A, based on parity tasks (ωₚ=20π (Tₚ=0.1 sec), Ω=ω₀=40π rad/s, N=1000 nodes, φ=π/3 rad, and the simulation time of 4000Tₚ=400 seconds). Plot (a) of FIG. 14 shows the second order parity, plot (b) of FIG. 14 shows the third order parity, plot (c) of FIG. 14 shows the fourth order parity, and plot (d) of FIG. 14 shows the fifth order parity. The color bar denotes the information metric R.

It is observed that a small limit cycle with a low forcing amplitude is ineffective for computation as expected. However, a band is observed for higher order tasks, which is unintuitive. This relationship can be used to maximize the computational ability of the oscillator. The information processing capacity can be changed by simply altering the input magnitude of a spintronic reservoir. The input magnitude can be varied to get a different limit cycle response in the spintronic oscillator. Similarly, the current Hopf RC varies the input magnitude by varying A to optimize the RC performance.

The external forcing frequency has been found to be important in determining a reservoir computer's performance. Tuning the forcing frequency of an RC created from an array of Duffing oscillators, Arnold tongue-like structures and topological mixing have been observed. In a similar manner, a parametric study was performed using the resonance constant ω₀ and harmonic forcing frequency Ω.

A resonance condition of the Hopf oscillator is achieved when the resonance constant and harmonic forcing frequency are equal (ω₀=Ω). FIG. 15 illustrates an example of a fine resolution parametric study of the Hopf RC's resonance constant ω₀ and harmonic forcing frequency Ω, based on parity tasks (ωₚ=20π (Tₚ=0.1 sec), μ=5, A=0.5, N=1000 nodes, φ=π/3 rad, and the simulation time of 4000Tₚ=400 seconds). Plot (a) of FIG. 15 shows the second order parity, plot (b) of FIG. 15 shows the third order parity, plot (c) of FIG. 15 shows the fourth order parity, and plot (d) of FIG. 15 shows the fifth order parity. The color bar denotes the information metric R. In plots (a)-(d), a band along a 45° angle in each of the ω₀−Ω parametric plots corresponds to this resonance condition. However, if the resonance condition (ω₀=Ω) is achieved, the reservoir's performance jumps suddenly from poor performance to successful computation. Hence, the resonance phenomenon is a necessary condition for the Hopf oscillator to function as an effective RC.

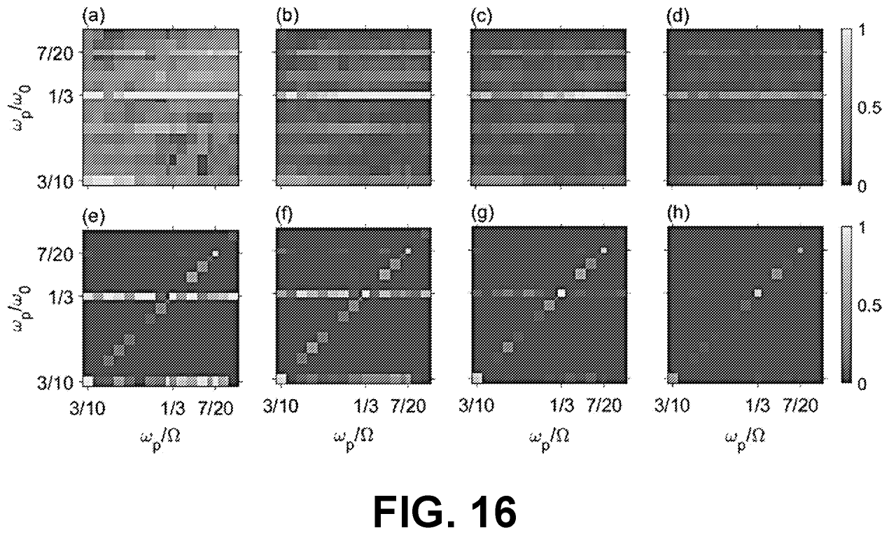

Another matching condition is met when ω₀ is an integer multiple of the pseudo-period, ωₚ (ω₀=zωₚ, where z∈ [symbol] ). This can be observed for all the parity tasks presented in FIGS. 15 and 16. The ω₀−Ω parametric space was also explored experimentally, which is presented in FIG. 16 by building an analog circuit that can be modeled with Eq. (4). Due to experimental limitations, a comparatively coarse parametric space is shown in FIG. 16, which illustrates an example of the coarse resolution experimental and numerical parametric qualitative study of the Hopf RC's resonance constant ω₀ and harmonic forcing frequency 2, based on parity tasks (ωₚ=20π (Tₚ=0.1 sec), μ=5, A=0.5, N=1000 nodes, φ=π/3 rad, and the simulation time of 4000Tₚ=400 seconds). The top row of FIG. 16 illustrates the analog circuit experiment with plot (a) of FIG. 16 showing the second order parity; plot (b) of FIG. 16 showing the third order parity; plot (c) of FIG. 16 showing the fourth order parity; and plot (d) of FIG. 16 showing the fifth order parity. The bottom row of FIG. 16 illustrates the numerical simulation with plot (e) of FIG. 16 showing the second order parity; plot (f) of FIG. 16 showing the third order parity; plot (g) of FIG. 16 showing the fourth order parity; and plot (h) of FIG. 16 showing the fifth order parity. The color bars denote information metric R. The experiments show a similar trend near the resonance and at the matching conditions. From FIG. 16, the best performance for a numerical reservoir can be found for the resonance condition where

$$\frac{{ω}_{p}}{Ω} = \frac{{ω}_{p}}{{ω}_{0}} = 1 / 3$$

the best performance for the experimental reservoir is found when

$$\frac{{ω}_{p}}{{ω}_{0}} = 0.333 and \frac{{ω}_{p}}{Ω} = 0.344 .$$

Deviation between the experiment and the simulation may be attributed to the precision of the circuit elements and nonlinear effects of the circuit (e.g., parasitic effects).

Next, the effects of the frequency ratio

$$\frac{{ω}_{p}}{{ω}_{0}}$$

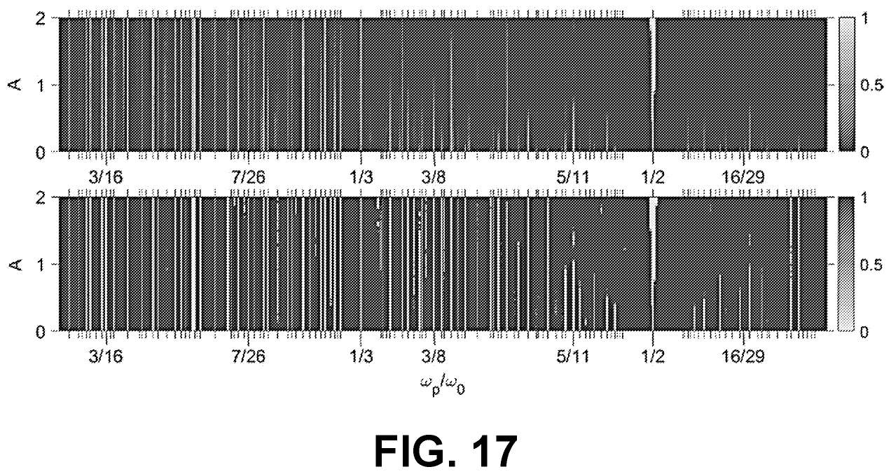

and the harmonic forcing amplitude A on the computational ability of the Hopf RC are shown in FIG. 17. The

$$\frac{{ω}_{p}}{{ω}_{0}} - A$$

parametric space was studied using the second order parity and chaotic laser intensity prediction tasks, whereas keeping the system parameters the same. For the chaotic time-series benchmark, the task for the RC was to predict one step ahead based on the previous steps. The RMSE was used as the performance metric for this task. To verify that frequency ratios from the Farey sequence are important to other tasks, a chaotic time-series benchmark can also be used to compare the performance with a nonbinary task. The harmonic frequency Ω is set to 40π such that the Hopf oscillator experiences resonance when

$$\frac{{ω}_{p}}{{ω}_{0}} = 1 / 2.$$

In FIG. 17, it can be observed that the Hopf reservoir can have high computational ability even when the resonance condition is not met.

In FIG. 17, the ratio of

$$\frac{{ω}_{p}}{{ω}_{0}}$$

is varied along the horizontal axis with values from the Farey sequence (30th order) marked with tick marks, and the forcing amplitude A is varied along the vertical axis. The top plot illustrates the second order parity task where the color bar denotes the information metric. The bottom plot illustrates chaotic laser time-series prediction where the color bar denotes performance based on the root mean square error (RMSE), which has been binarized to be high (logical 1) if RMSE>0.3 and low (logical 0) for RMSE≤0.3. For these tasks, μ=5, Ω=40π rad/s, N=1000 nodes, β=0 rad, ωₚ=20π rad/s (Tₚ=0.1 sec), and the simulation time is 3000Tₚ=300 seconds. In both cases, the computational ability of the Hopf RC is strongly predicted by

$$\frac{{ω}_{p}}{{ω}_{0}}$$

aligning will a Farey sequence number.

From FIG. 17, it is observed that the Hopf RC has a high computational ability when

$$\frac{{ω}_{p}}{{ω}_{0}}$$

is a number from the Farey sequence from number theory. Using a 30th order Farey sequence, it can be observed that the reservoir's computational ability is strongly influenced by the frequency ratio

$$\frac{{ω}_{p}}{{ω}_{0}} ,$$

matching a number from the Farey sequence. To influenced by the frequency ratio observe the correlation between the Farey ratio and the RC's performance for the chaotic time-series task, the RMSE was binarized to be high (logical 1) if RMSE>0.3 and low (logical 0) for RMSE≤0.3. The Farey sequence is found in many natural phenomena, such as in the auditory system, the resonance diagrams of accelerators, mode locking in quantum accelerators, and cardiac dysrhythmias. However, this is when the Farey sequence has been reported in the context of reservoir computing.

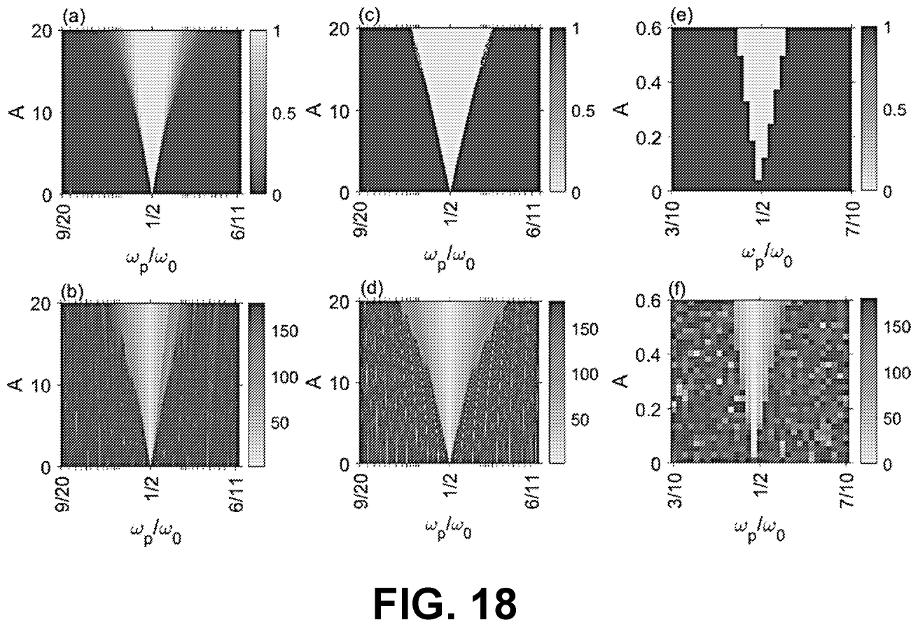

FIG. 18 illustrates how synchronization plays an important role in the RC's computational ability, which is observed as an Arnold tongue around the resonance region where

$$\frac{{ω}_{p}}{{ω}_{0}} = \frac{1}{2} .$$

Plot (a) of FIG. 18 depicts the simulation showing an Arnold tongue region for the second order parity task for the RC. The color bar denotes the information metric R. Plot (b) of FIG. 18 depicts the simulation showing an Arnold tongue region in the second order parity task for the Hopf oscillator. The color bar denotes the phase lag (degrees) between the Hopf oscillator response x and the external forcing (sin Ωt+φ). Plot (c) of FIG. 18 depicts the simulation showing an Arnold tongue region in the chaotic time-series task for the RC. The color bar denotes the RMSE. Plot (d) of FIG. 18 depicts the simulation showing an Arnold tongue region in the chaotic time-series task for the Hopf oscillator. The color bar denotes the phase lag (∘). Plot (e) of FIG. 18 depicts an experiment showing an Arnold tongue region in the chaotic time-series task for the RC. The color bar denotes the RMSE. Plot (f) of FIG. 18 depicts the experiment showing an Arnold tongue region in the chaotic time-series task for the Hopf oscillator. The color bar denotes the phase lag (∘). In plots (c) and (e), RMSE has been binarized to be high (logical 1) if RMSE>0.1 and low (logical 0) for RMSE≤0.1. For these tasks, ωₚ=20π rad/s (Tₚ=0.1 sec), μ=5, A=0.5, N=1000 nodes, and ø=0 rad.

Plots (b), (d) and (f) of FIG. 18 show the phase difference between the Hopf oscillator's x state and the harmonic forcing sin (Ωt+q) for parity and chaotic time-series prediction tasks. When

$$\frac{{ω}_{p}}{{ω}_{0}}$$

is near ½, a resonance relationship forms an Arnold tongue in the

$$\frac{{ω}_{p}}{{ω}_{0}} - A$$

space. These tongues are formed both in the reservoir's performance metric space and in the oscillator's phase deviation space. It is noted that the phase difference is not constant throughout the time history. Hence, the maximum phase difference is taken into consideration by binning the response, taking fast Fourier transforms, and then plotting the maximum phase difference. Arnold tongue-like regions were also found in a reservoir computer composed of a Duffing oscillator array. The Hopf RC performs best when this resonance condition holds. In plots (a), (c) and (e) of FIG. 18, an Arnold tongue is observed in the performance space of the reservoir when the Hopf RC operates near the resonance frequency. Here, plots (e) and (f) of FIG. 18 depict Arnold tongues for the experimental Hopf RC, and plots (a)-(d) of FIG. 18 are found from numerical simulations.

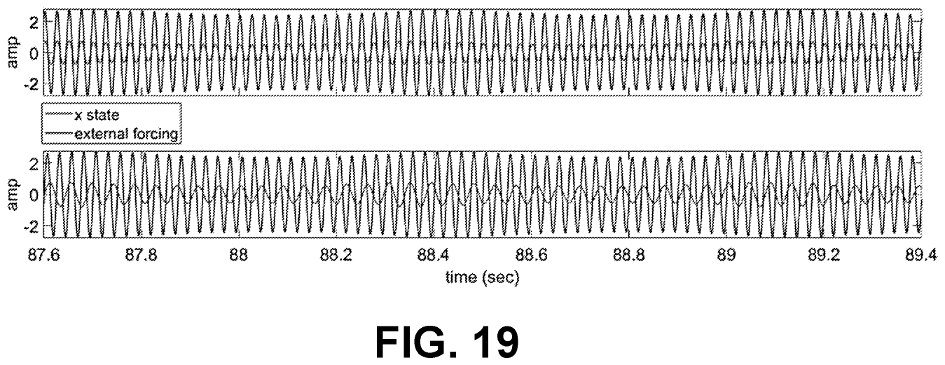

FIG. 19 shows the time history of the oscillator's response when it is locked with the forcing and when it is not phase locked. FIG. 19 illustrates the time series of the x state of the Hopf RC is shown for a portion of the chaotic time-series task. The top plot of FIG. 19 shows the Hopf RC is at resonance (ω₀=Ω), and the oscillations are locked with the external forcing. The bottom plot of FIG. 19 shows the Hopf RC is not at resonance (ω₀=1.7391*Ω), and the oscillations are not locked with external forcing. Here, ω₀=20π, ωₚ=20π rad/s (Tₚ=0.1 sec), μ=5, A=0.5, N=1000 nodes, and φ=π/3 rad.

The tongue region may be particularly important in experimental design. For this tongue region, there is a range of frequency ratios centering on the resonance frequency, which can result in better computation. Hence, this is the only region found where the reservoir has some tolerance to mistuning. This implies that the synchronization in the Arnold tongue region causes robust computing. There is also a comparatively broader range of amplitudes and frequency ratios available for which the resonance constant can be tuned such that the Hopf RC has high computational ability whereas staying inside the Arnold tongue. It is noted that the presented studies were performed considering no masking in the system. The presence of robust computational ability despite the absence of a masking function suggests that a single nonlinear node based reservoir can also be reliably constructed discarding the conventional periodic or nonperiodic mask.

To understand the effect of resonance on computation, the memory capacity of the Hopf oscillator reservoir is calculated. For a δ delayed nth order parity function given in Eq. (19), the memory capacity of a system can be calculated as follows:

$${MI}_{n , δ} = {p}_{n , δ} {log}_{2} ( 2 {p}_{n , δ} ) + ( 1 - {p}_{n , δ} ) {log}_{2} [ 2 ( 1 - {p}_{n , δ} ) ] , \qquad ( 20 )$$

$${MC}_{n} = {\sum }_{δ = 0}^{∞} {MI}_{n , δ} .$$

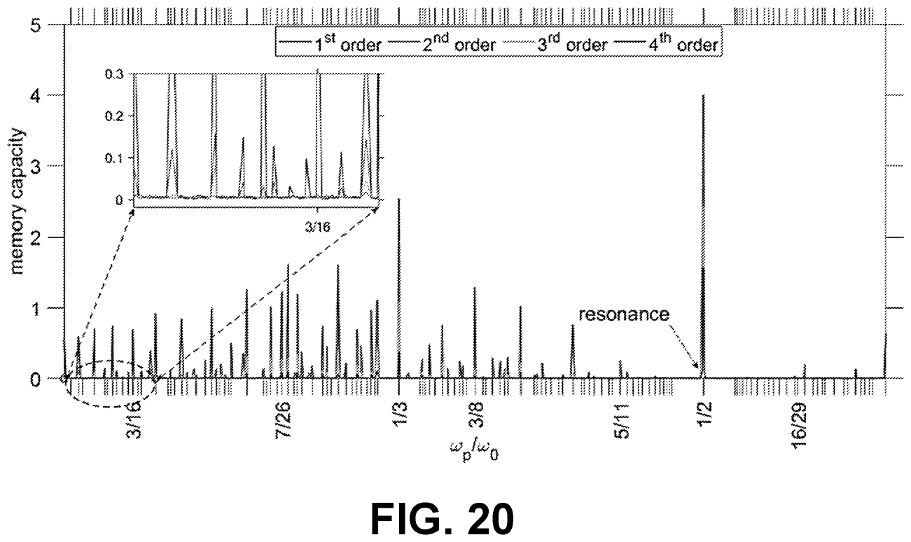

FIG. 20 illustrates memory capacity calculations of the Hopf RC with δ delayed first, second, third, and fourth order parity tasks (8=0 to 10). Here, ωₚ=20π (Tₚ=0.1 sec), Ω=40π, A=0.5, μ=5, N=1000 nodes, and φ=π/3 rad, and simulation time is 4000Tₚ=400 seconds. The memory capacity (bits) is plotted against

$$\frac{{ω}_{p}}{{ω}_{0}}$$

in FIG. 20, which shows that the reservoir possesses highest memory at the resonance condition when

$$\frac{{ω}_{p}}{{ω}_{0}} = \frac{1}{2} .$$

Hence, with sufficient nonlinearity being present at this condition, the Hopf oscillator should conduct better computation than at other parametric combinations. This explains the superior computing performance of the resonance condition as seen in FIGS. 15-18.

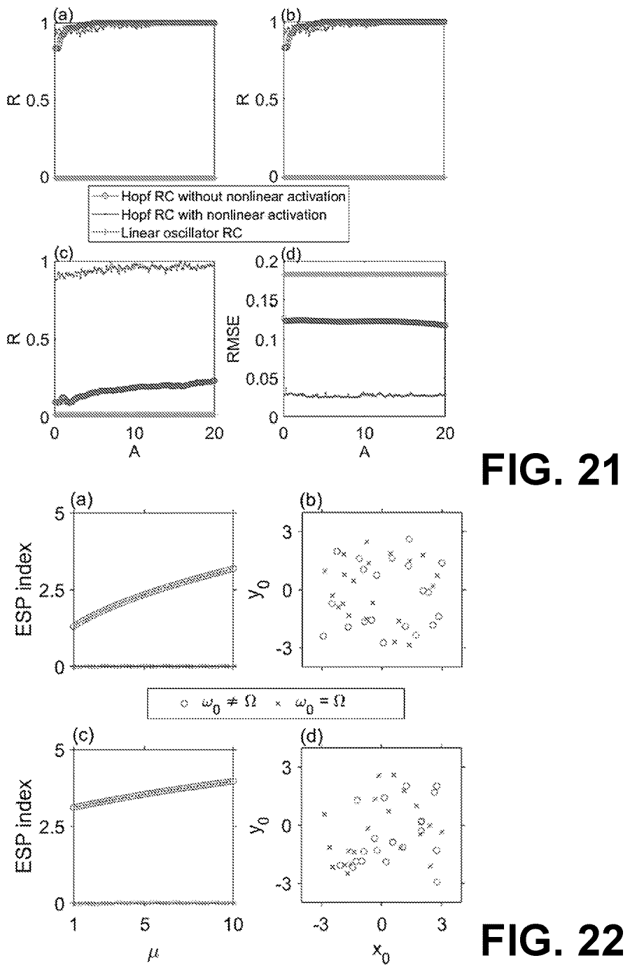

The effect of the nonlinear activation function (tan h⁻¹ X) on the performance of the Hopf oscillator RC is also studied, and the results are presented in FIG. 21, which illustrates the effects of nonlinear activation function on the Hopf RC's performance (ωₚ=20π (Tₚ=0.1 sec), ω₀=40π, μ=5, N=1000 nodes, and φ=π/3 rad, and simulation time is 4000Tₚ=400 seconds). Plot (a) of FIG. 21 shows the second order parity, plot (b) of FIG. 21 shows the third order parity, plot (c) of FIG. 21 shows the fourth order parity, and plot (d) of FIG. 21 shows the chaotic time series. It is found that in the absence of nonlinear activation, the Hopf oscillator RC shows similar performance for lower order tasks (e.g., second and third order parity tasks). However, the nonlinear activation function becomes important in performing higher order tasks. Hence, the base Hopf oscillator dynamics has some level of computing ability. Furthermore, a linear oscillator is also tested as a reservoir computer in the presence of a nonlinear activation function. In this case, the nonlinear activation function cannot make the linear oscillator act as a reservoir computer. This is similar to the effect of nonlinearity in the acoustic transformation for a digit recognition task.

The ESP is one of the basic properties found in a successful reservoir computing framework. Previous limit cycle-based systems were not found to satisfy ESP requirements, however the Hopf RC formulation described in this disclosure is different since the limit cycle radius keeps changing depending on the forcing used to encode the information. Additionally, the resonance phenomenon was taken into consideration to build the reservoir system. In the literature, generalized synchronization or common signal induced synchronization were used to verify the existence of ESP in a reservoir. ESP has been empirically studied to measure the stability of input-driven reservoir dynamics. It is implied that a reservoir possesses the echo state property if the asymptotic trajectory of the reservoir state relies distinctively on the inputs and is independent of the initial conditions. Hence, to obtain the echo state property, the effect of the initial conditions on the reservoir dynamics should fade as the time progresses.

The echo state property of the Hopf reservoir was studied when the reservoir is encoded with the inputs of the chaotic laser time-series task and a parity task. Following the algorithm of estimating ESP of a reservoir, an ESP index was calculated for the two benchmarks, which is averaged over 20 randomly generated initial conditions in the range of {−3,3}. The deviation of the reservoir state trajectories for different initial conditions was calculated using the same input sequence for all of the different initial conditions. To calculate the deviation, initial conditions of (x₀,y₀)=(0,0) were used as the common trajectory whereas the other trajectory came from each of the different initial conditions, whereas discarding the initial transients. Finally, an average of the deviation is calculated to find the ESP index. If the ESP index goes to zero for a reservoir's dynamics, the reservoir is said to possess the echo state property. These results are given in FIG. 22 where it is observed that the reservoir has the echo state property for the resonance condition (ω₀=Ω), whereas it does not possess this property when the resonance is not met (ω₀≠Ω). This can also explain why the resonance helps in computation. It is also important to note that a reservoir may still have information processing capability when the ESP is not met.

FIG. 22 illustrates the echo state property (ESP) index calculation for the Hopf RC for the chaotic laser time-series task and the parity task. Plot (a) of FIG. 20 shows the ESP index for resonance and nonresonance conditions for the chaotic time-series task, plot (b) of FIG. 20 shows one set of random initial conditions (x₀ and y₀ chosen from {−3,3}) for the chaotic time-series task, plot (c) of FIG. 20 shows the ESP index for resonance and nonresonance conditions for the parity task, and plot (d) of FIG. 20 shows one set of random initial conditions (x₀ and y₀ chosen from {−3,3}) for the parity task. Here, ωₚ=20π (Tₚ=0.1 sec), ω₀=80π, φ=π/3 rad, A=0.5, and simulation time is 3000Tₚ=300 seconds. For the resonance condition Ω=ω₀ and for the nonresonance condition Ω=1.7391ω₀.

In this disclosure, the Hopf oscillator was constructed as a reservoir computer to gain insights into the relationship between the oscillator's dynamics and the RC's computational ability. This implementation of a Hopf reservoir computer offers a simpler design by discarding the popularly used delayed feedback line and masking function. An analog electrical circuit was used as a physical realization of the reservoir. The reservoir demonstrates high computational ability when the ratio of the pseudo-frequency of the input ωₚ and the natural frequency of the oscillator ω₀ are taken from the Farey sequence. Additionally, a resonance phenomenon happens when the harmonic forcing frequency and natural frequency of the oscillator are equal, which provides a favorable condition to construct the reservoir computer. Enhanced computational ability can be achieved when the limit cycle radius is relatively small whereas the forcing amplitude is relatively large. An Arnold tongue structure was observed in the reservoir's information metric space near the resonance location, which is correlated with an Arnold tongue exhibited in the phase deviation space. The reservoir was also found to possess both maximum memory capacity and the echo state property when the resonance condition is met, which is indicative of better computing performance in principle. Finally, the results also suggest that a reservoir computer can be constructed with only a single nonlinear node and neither a time-multiplexing process nor a delayed feedback. By harnessing some of the underlying dynamics of the system, limit cycle reservoir computers can be constructed that are both simple and robust.

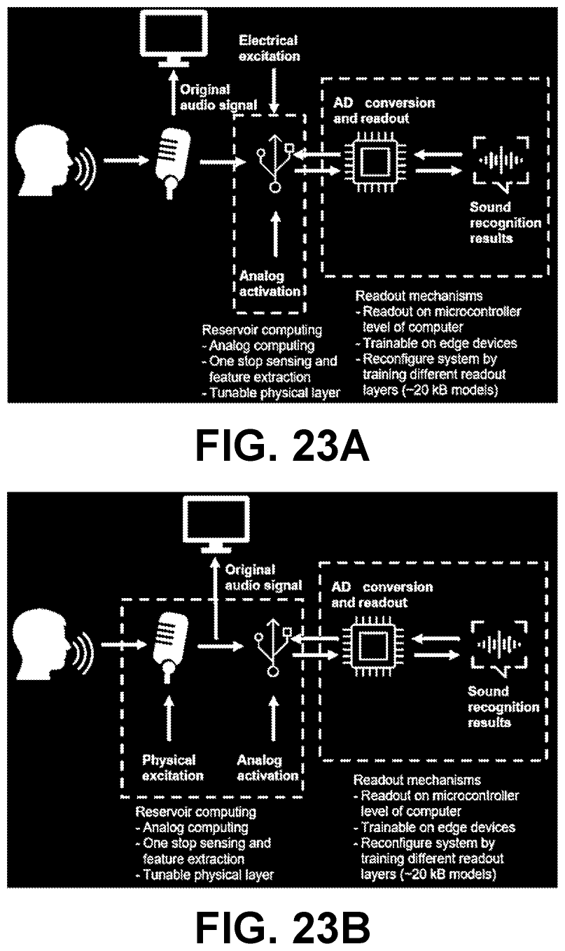

A no-delay, stochastic limit cycle oscillator reservoir computer can be utilized with a range of technologies for recognition tasks. The limit cycle oscillator can be paired with vibratory signals such as, but not limited to, speech recognition or other soundscapes. As limit cycle oscillators are already vibratory systems, this pairing is beneficial in applications such as those implemented in an edge device. For example, the no-delay, stochastic limit cycle oscillator reservoir computer can be paired with microphone technology for sound recognition tasks. FIGS. 23A and 23B illustrate an example of the PRC implemented with microphone technology for sound recognition tasks. The system of FIG. 23A includes a PRC and a readout. The PRC provides processing immediately after the microphone that eliminates data preprocessing, enables fast analog computing and tunable physical layer on different tasks. The readout can be reconfigured for different tasks, directly deployed on an edge device, and can include a feedback loop to boost the computational performance of PRC. Similarly, the system of FIG. 23B includes a PRC for processing with sensing that eliminates data preprocessing, enables fast analog computing and tunable physical layer on different tasks, and a readout that can be reconfigured on different tasks, directly deployed on an edge device, and can use a feedback loop to boost the computational performance of the PRC.

The no-delay, stochastic limit cycle oscillator reservoir computer can also be integrated into a number of MEMS designs such as, but not limited to, cantilever beams, condenser microphones, parallel plate actuators, mechanical duffing oscillators, quantum sensing, etc. The limit cycle oscillator reservoir computer can also be integrated into optoelectronic designs (such as in “Theoretical and experimental study of slow-scale Hopf limit-cycles in laser-based wideband optoelectronic oscillators” by G. R. G. Chengui et al., J. Opt. Soc. Am. B, Vol. 31, No. 10, p. 2310-2316. October 2014), nanoelectromechanical designs (NEMS such as in “Limit Cycle Oscillations in CW Laser-Driven NEMS” by K. Aubins et al., J. of Microelectromechanical Systems, Vol. 13, No. 6, pp. 1018-1026, December 2004), semiconductor laser designs (such as in “Limit-Cycle Dynamics with Reduced Sensitivity to Perturbations” by T. B. Simpson et al., Physical Review Letters 112, 023901, January 2014), thermoacoustic designs (such as in “Effect of amplitude and frequency of limit cycle oscillators on their coupled and forced dynamics” by D. Premraj et al., Nonlinear Dyn 103:1439-1452, February 2021), and quantum dot designs (such as in “Excitability in a Quantum Dot Semiconductor Laser with Optical Injection” by D. Goulding et al., Physical Review Letters 98, 15393, April 2007). Several sound recognition benchmarking tasks have been completed to explore the Hopf bifurcation as the processing mechanism. The machine learning of the readout layer can use a ridge regression with training time less than 1 minute. The MEMS bifurcation point and the excitation signal can both be tuned to enhance its processing ability. Examples of results obtained using a simulated RC are shown in the table below. Benchmark tests such as these (see also, e.g., FIGS. 9-12) validate the application of the limit cycle oscillator reservoir computer.

| Input | Output | Incumbent |
|---|---|---|
| Urban sound | 86.3% accuracy | https://arxiv.org/abs/2103.12157, note: on the |
| recognition (10 | (~100 Hz to 7000 | edge with microcontroller w/o analog |
| classes) | Hz) | computing |
| Speaking command | 84.5% accuracy | https://arxiv.org/abs/2008.10984, transformer |
| dataset (35 classes) | (~200 Hz to 3000 | trained on AWS, deployed on the wake words |
| | Hz) | chip |
| Music genre dataset | 82.8% accuracy | https://www.kaggle.com/code/lujar1762/music- |
| | (~100 Hz to 10 kHZ) | genre-classification-with-wav2vec2 |

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A physical reservoir computer, comprising:
processing circuitry comprising:
an input layer;
a reservoir comprising a forced limit-cycle oscillator, the reservoir implemented without delay or feedback; and
a readout layer.

2. The physical reservoir computer of claim 1, wherein the forced limit-cycle oscillator comprises a Hopf oscillator or a Lorenz oscillator.

3. The physical reservoir computer of claim 2, wherein the forced limit-cycle oscillator comprises a two-state forced Hopf oscillator.

4. The physical reservoir computer of claim 1, wherein the processing circuitry comprises analog processing circuitry.

5. The physical reservoir computer of claim 4, wherein the analog processing circuitry comprises operational amplifiers and multipliers.

6. The physical reservoir computer of claim 1, wherein the reservoir computer utilizes a non-periodic stochastic mask.

7. The physical reservoir computer of claim 6, wherein the non-periodic stochastic mask is defined by white Gaussian noise.

8. The physical reservoir computer of claim 1, wherein the processing circuitry comprises optoelectronic circuitry.

9. The physical reservoir computer of claim 1, wherein a vibratory signal is applied to the input layer.

10. The physical reservoir computer of claim 9, wherein the vibratory signal is a speech signal.

11. The physical reservoir computer of claim 1, wherein the readout layer is trained to map states of the forced limit-cycle oscillator to a desired output.

12. The physical reservoir computer of claim 11, wherein training of the readout layer comprises linear regression or ridge regression.

13. The physical reservoir computer of claim 11, wherein the desired output is a logical output.

14. The physical reservoir computer of claim 13, wherein the logical output is an XOR output.

15. The physical reservoir computer of claim 1, wherein the input layer encodes an applied signal for input to the reservoir.

16. The physical reservoir computer of claim 15, wherein the applied signal is encoded as a continuous input function.
